(19) United States
(12) Patent Application Publication
(10) Pub. No.: US 2005/0068891 A1
(43) Pub. Date: Mar. 31, 2005

(54) Method and apparatus for network throughput measurement

(76) Inventors: Amarnath R. Arsikere, Palatine, IL (US); Igor A. Shvyrkov, Mundelein, IL (US)

Correspondence Address: Edmund J. Walsh;Wolf, Greenfield & Sacks, P.C., 600 Atlantic Avenue, Boston, MA, 02210, US

(21) Appl. No.: 10/671,154

(22) Filed: Sep. 25, 2003

(51) Int. Cl. H04J 1/16

(52) U.S. Cl. 370/232

(57) ABSTRACT

A system for measuring the throughput of a network. Blocks of data are transmitted and the data rate of each block is determined. An accurate measurement is made by collecting and averaging the throughput of certain ones of blocks. The system is illustrated in connection with a diagnostic unit connected to a call center. Upon the occurrence of a customer problem, a user is directed to a diagnostic web page. Once the user computer has accessed the web page, the diagnostic unit can either send blocks of data to the user computer or can embed code in the web page that causes the user computer to send blocks of data to the diagnostic unit.

### BACKGROUND OF INVENTION

1. Field of Invention This invention relates generally to data networks and more particularly to testing data networks.

2. Discussion of Related Art

Data networks are widely used. Most offices and even many homes include local area networks. Many businesses employ wide area networks that link local area networks in different places. And, the Internet is widely used in business and by people in their homes to allow users to access data from computers located all over the world.

The data carried by the Internet might represent text, graphics, audio, video or other types of information. Herein, the Internet will be used as an example of a data network.

The proliferation of data networks creates the need for network test tools. Testing is used to find faults in the network and also to verify that the quality of service provided by the network is adequate. For example, an Internet Service Provider (ISP) sells access to the Internet and must ensure that its customers can exchange data with computers on the network at a level consistent with the level of service sold by the ISP. The rate at which data can be passed between two devices that are part of or connected through a network, more generally termed “nodes,” is termed the throughput.

A low throughput might indicate a physical fault in some piece of network equipment, such as the wires, a server, a router or other network node. Or, a low throughput might be an indication that the network devices are not configured properly or that the network lacks sufficient equipment to simultaneously carry data for all network users.

Regardless of the reason why throughput is inadequate, a network user will experience poor service. To keep its customers satisfied or to ensure that it can charge a premium for high throughput network connections, ISPs want to know the throughput between various nodes in the network.

Teradyne of Deerfield, Ill. provides a product called NetFlare™ to help ISPs or other network operators keep track of the quality of service provided to its customers. One function of this product is to be able to measure throughput.

The traditional approach to measuring throughput is to simply send a block of data from one node of the network to another. By measuring the length of time it takes to transmit the block, the rate at which the data was transmitted can be computed—which is an indication of the throughput.

There are several short comings of this approach. One short coming is that the amount of data that must be transmitted to accurately measure the throughput depends on the throughput. For example, a link between two nodes that should be transmitting data at only 56 kilo-bits per second would need to transmit a much smaller amount of data to get a reasonable sample of network performance than a link operating at 100 Mega-bits per second.

Further, the approach of sending a data sample that is large enough to accurately measure the throughput of a network connection regardless of the speed at which it operates is generally inadequate. If the data sample is large enough to provide an accurate measurement at high speeds, it will take a very long time to run the test if the network is actually operating at a lower speed. The test might take more time than is acceptable to a network user to complete. Additionally, if the test places large amounts of data on a relatively slow network, the test data itself might overload the network or otherwise slow down its operation.

Most systems that make throughput measurements limit the time during which a throughput measurement will be attempted. If the test data is not transmitted within the specified amount of time, the test is terminated. However, if the test is terminated before the test data is transmitted over the link under test, the test system can not distinguish between a defect in the link blocking transmission of data or a situation in which the network is operating with a very low throughput.

Some systems attempt to resolve these problems with throughput measurements by getting an estimate of the network throughput from an operator and then running the test with an amount of data appropriate to make an accurate throughput measurement at this data rate. For example, a utility called PCPITSTOP.COM operates in this fashion. When the link is predicted to have a low data rate, a smaller amount of data is used so that the test data will be transmitted during the time limit set for the test.

There are several drawbacks of this approach. One is that the operator might not know the expected throughput of the link and therefore provide inaccurate information. The other problem is that throughput tests are often run when there is a problem on the network and it is not operating at its intended data rate. Thus, the user input could still result in specifying a test data package that is larger than suitable for the network.

It would be desirable to have an improved technique that could be used to measure throughput of a network.

### SUMMARY OF INVENTION

With the foregoing background in mind, it is an object of the invention to provide a more convenient and accurate system and method to measure throughput of a network.

It is also an object to provide a system and method to measure throughput of a network that does not burden the network.

It is also an object to provide a system and method of measuring throughput in both the upstream and downstream links of an ADSL network or cable broadband network.

The foregoing and other objects are achieved using a process in which multiple blocks of data are transmitted. The transmit time of each block is measured. The measurement proceeds until an accurate throughput measurement is obtained or a predetermined time elapses.

In one embodiment, the throughput of upstream link in an ADSL network is measured by having a user interface to a web server that provides an HTML page. The HTML page includes a test payload and a JavaScript® script that automatically transmits the payload in blocks to a server.

In yet another embodiment, throughput measurements made for individual blocks are statistically analyzed to increase the accuracy of the measurements. Statistical analysis is preferably used only for “non-bursty” networks.

### BRIEF DESCRIPTION OF THE DRAWINGS

The invention will be better understood by reference to the following more detailed description and accompanying drawings in which

FIG. 1 is a sketch of a network that might use the invention;

FIG. 2 is flow chart of a process for computing a bit rate; and

FIG. 3 is a flow chart of process for computing a bit rate in the upstream direction.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

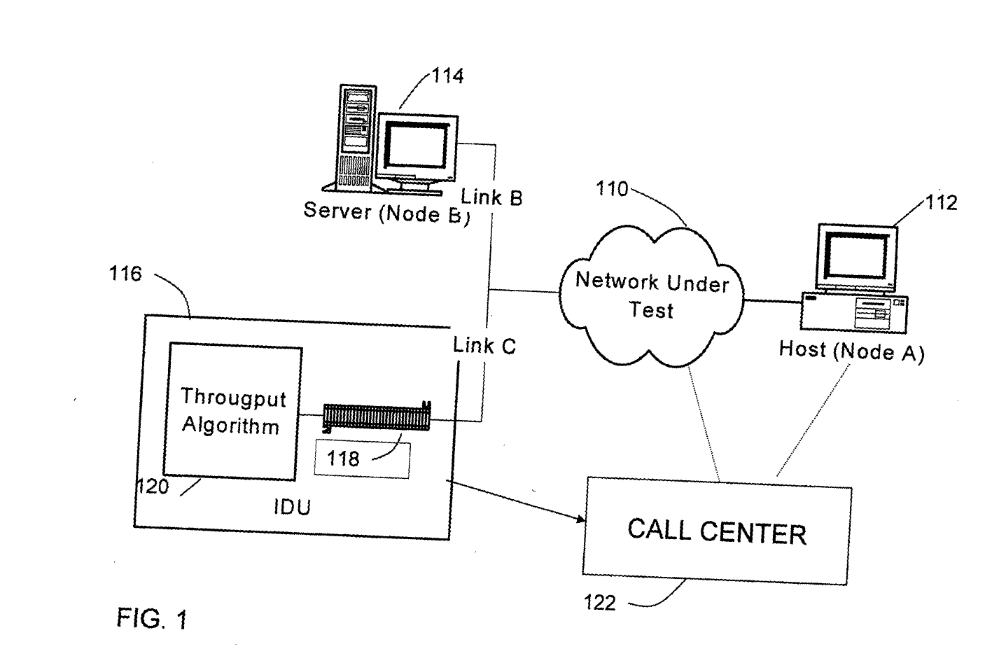

FIG. 1 shows in greatly simplified form a network 110 in which the throughput will be measured. The preferred embodiment of the invention will be described in connection with measuring the throughput experienced by a user accessing the internet. In this case, network 110 represents an access network provided by an internet service provider. However, the invention is not limited to use in this application.

Data terminals are connected to the network. In FIG. 1 computer 112 is representative of a data terminal. Computer 112 might be for example a home computer.

When using the internet, a user accesses other data terminals over network 110. In the example of FIG. 1 where the network under test is the internet, these data terminals are most likely servers that receive or provide information to the internet user. Server 114 is representative of these data terminals. It should be appreciated that the internet has many users connected to it and many servers, but only two are shown for simplicity. The precise type of equipment used to implement computer 112 or server 114 is not important to the invention. However, the preferred embodiment will be described herein as using a computer 112 that includes a standard internet browser. In the described embodiment the browser can receive and respond to HTML pages including those with JavaScript® programs.

FIG. 1 shows a diagnostic unit 116 also connected to the network. In the preferred embodiment, diagnostic unit 116 is of the type sold by Teradyne, Inc. of Deerfield, Ill. under the name of Netflare®. However, any diagnostic unit capable of executing the programs as hereafter described could be used. Moreover, it is not necessary that a separate diagnostic unit be used. The programs described below might be executed on any computer connected to the network under test 110. For example, the programs might be executed in server 114.

Diagnostic unit 116 is programmed to execute a throughput measurement algorithm 120. As will be described in greater detail below. Throughput algorithm 120 is implemented in diagnostic unit 116 as a computer program. This computer program can be written in any convenient language. However, an advantage of the preferred embodiment is that the throughput program can be written as a computer application. In the preferred embodiment, this application uses standard computer utilities to manage communications over network 110. In the terminology of the OSI five layer model of network protocols, the throughput program is implemented at layer five and does not require modification of standard software or hardware that implements layers 1-4 of the network.

FIG. 1 shows that diagnostic unit 116 unit contains a buffer 118 between the network and the software that runs throughput algorithm 120. Buffer 118 represents a function performed by the operating system of most computers and servers. As an application program generates data to be sent over the network, the operating system will generally buffer the data until the operating system determines that a message is ready to be sent over the network. For example, a traditional network protocol specifies that messages are sent in packets, with each packet having some of control bits and some number of data bits. If the operating system transmitted every byte of data as it received it from an application program, each packet would have many control bits and relatively few data bits. Thus, most of the network traffic would be devoted to transmitting control information and very little for actual data transmission, resulting in an inefficient network.

Ordinarily, buffer 118 is desirable. However, when measuring network throughput, a buffer can be undesirable. The buffer can introduce a variable amount of delay in the transmission of messages from an application program. In the preferred embodiment, the throughput measurement software is implemented as an application program. But, to avoid the variable delay that might be introduced by the operating system, the preferred embodiment, as described below, is designed to avoid any significant delays caused by buffering.

In the preferred embodiment throughput measuring program 120 measures the data rate for communications through network 110 through computer 112 or from computer 112 through network 110 to server 114. These measurements are generally referred to as the upstream and downstream throughput, respectively.

In the preferred embodiment the data obtained from throughput measurements is used by the internet service provider to provide customer care. The throughput measurements are provided to a call center 122. Call center 122 refers to a facility operated by the internet service provider where its customers can direct complaints about their network service. Generally, call center 122 will be staffed by human operators that receive phone calls or electronic communications from customers. It should be appreciated though that call center 122 does not have to be a physical location. Customer service operators might be located at any place where they can receive communications from customers. For example customer service operators might be included in the network operations center (NOC). It should also be appreciated that customer service need not be provided by a human operator. Various artificial intelligence techniques are known for automated response to customer complaints.

In the preferred embodiment, a customer contacting call center 122 with a complaint about the throughput of their network connection will be instructed to use their computer 112 to access diagnostic unit 116. Preferably, diagnostic unit 116 appears to the user as a server that it can access over network 110. To facilitate a connection between computer 112 and diagnostic unit 116, call center 122 provides the user with the web address of the diagnostic unit 116. It should be appreciated though that a user might obtain the web address of the diagnostic unit 116 other than from call center 122. For example the web address of diagnostic unit 116 might be downloaded from a self service website.

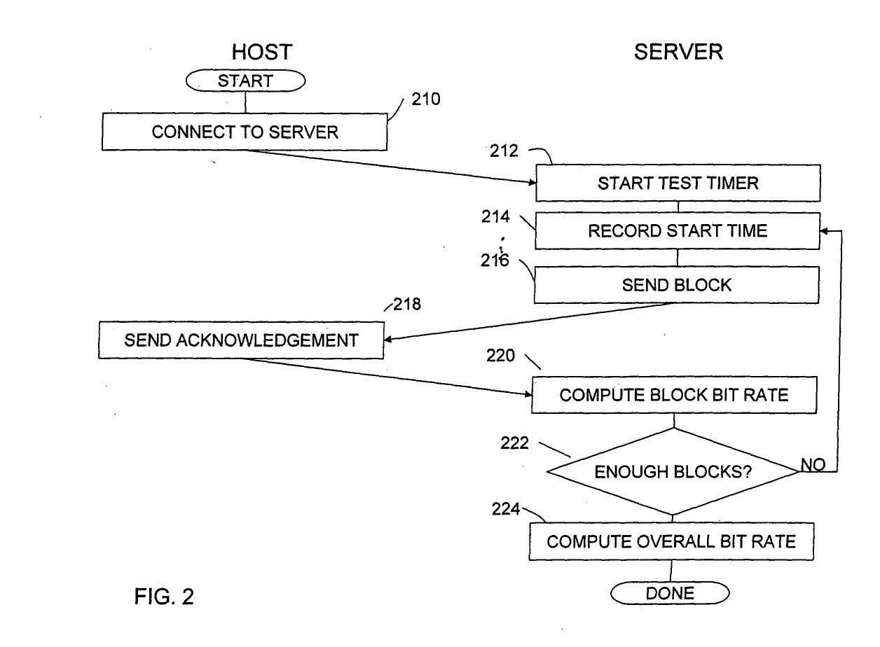

Regardless of how the connection between computer 112 and diagnostic unit 116 is initiated, once that connection is established the throughput algorithm can be performed. FIG. 2 shows the portion of the process for measuring the downstream throughput. The steps illustrated on the left side of FIG. 2 are in the preferred embodiment performed on computer 112 acting as the “host”. The steps on the right side of FIG. 2 are performed on a computer acting as a server. In the preferred embodiment that computer will be diagnostic unit 116.

The process begins at step 210 when the host computer connects to the server. As described above, the connection in the preferred embodiment is made when the user computer 112, acting as a host, logs onto a diagnostic web page.

Once the connection is established, the process proceeds to step 212, which is performed on the server. At step 212, a test timer is started. Preferably, the throughput measurement will be completed within a predetermined maximum amount of time, regardless of the throughput on the network. The test timer started at step 212 will keep track of the maximum allowed test time. If the maximum allowed time is exceeded and the test has not completed, the test timer will time out and the test will be stopped. Many ways are known in the art to cause a process to time out. For example, time out of the test timer might trigger a software interrupt. Alternatively, the process might include a step of repetitively polling the time in the timer and the process would be ended at any time the polling indicated that the timer had timed out. The precise method of causing the test to time out is not important to the invention.

At step 214 a separate time keeping process is begun. This time keeping process is used to measure the amount of time it takes to transfer one block of data from the server to the host. Step 214 establishes the beginning of the transfer interval. In the preferred embodiment, the beginning of the transferred interval is recorded by recording the time indicated by a system clock. However, many alternative ways of measuring time intervals are known and the specific method used is not critical to the invention.

Processing proceeds to step 216. At step 216, a block of data is sent from the server to the host computer As is described above, step 216 is preferably implemented as an application program on diagnostic unit 116. It relies on existing system utilities programmed in diagnostic unit 116 to actually transfer data over network 110. However, in order for an applications program to accurately measure transmission time of a block of data, blocks of data sent from the application layer must pass through the hardware and software of diagnostic unit 116 that implement layers 1-4 of the OSI network model without delay caused by buffering. To ensure that a block of data is not buffered as it passes through layers 4-1 in the network protocol, the size of the block of data should be selected to fill a packet of data that will be sent over network 110 in accordance with the lower level network protocol. It is also desirable to set the socket buffer size to reduce the chance of messages being buffered with variable delay.

In the preferred embodiment, the application program performing the throughput test runs on a standard operating system. In one embodiment, this operating system is Linux. In such an environment, a connection between the host and the server is represented as a “socket.” When the application program accesses a particular socket, the operating system controls the underlying software and hardware to send messages in appropriate format over the network. Though the application program that controls the throughput measurement preferably does not directly control the underlying hardware and software, it does, in a preferred embodiment, set parameters of the socket to reduce the chance that messages will be delayed. In particular, the socket buffer size is changed. Preferably, the socket buffer size is changed on a per socket basis and is changed just for the socket used for throughput measurement so that other communications are not disrupted. Because the software controlling the TCP session will set the TCP window for the particular session corresponding to the socket to a size that is smaller than the socket buffer, adjusting the socket buffer from the application level indirectly impacts the lower level network operations. Thus, the selection at the application level of an appropriate size for the block size and the socket buffer size results in more accurate throughput measurements.

For example, in a conventional operating system, the socket buffer size might default to approximately 64K. We have found that reducing the socket buffer size to approximately 9 Kbytes results in more accurate measurements. This value was selected partially empirically. A test setup was created in a laboratory environment. Actual throughput was measured using a packet analyzer. The buffer size was adjusted until the measurements using the technique as described herein approximated the actual throughput as measured by the packet analyzer. However, the buffer size could not be made smaller than the block, otherwise, the buffer would overflow before receiving even a single packet.

To set the block size, the network protocol is considered. For example, data is transmitted over the internet using an ethernet protocol. The ethernet protocol specifies that the frame size of messages transferred over the network should be 1,518 bytes. Certain of the information in a frame is for control, leaving space for 1,497 bytes of data. The data contained in a frame or message packet is sometimes referred to as the payload. In the preferred embodiment, the block of data sent at step 216 preferably is the same size as the maximum message payload specified by the network protocol.

It will be appreciated that the preferred payload size will vary from network to network. However, we have recognized that measuring throughput using blocks of data that are approximately equal to the payload size provides several advantages. One advantage, as described above, is that it allows the test to be performed without the application program needing to have direct control over the TCP stack or other low level network element. A second advantage is that it allows one block of data to be sent in a time that will be ordinarily much less than the total time allocated to perform the throughput measurement test. In this way, most throughput measurements can be made using multiple blocks of data. These measurements can be averaged to create a more accurate measurement of throughput. Preferably, the block size is selected to also take into account the fact that some network connections will be slow and performing a test that requires a large block of data might not allow the test to finish in the allotted time. In the preferred embodiment, the block size is selected to measure network throughputs in the range of 56 Kbps to 8 Mbps, resulting in a block size in the range of 1.2 Kbytes to 2.5 Kbytes, with the preferred size being approximately 2 Kbyes.

When the host receives the block of data, it responds as indicated at step 218 by sending an acknowledgement. When the server receives that acknowledgement, processing continues at step 220. The time at which the acknowledgement message is received is recorded at step 220. This time is compared to the start time set at step 214 to determine the transmit time of the block of data. By dividing the size of the block by the transmit time, the bit rate—or throughput—during the transmission of the block can be computed.

Execution then proceeds to step 222. At step 222 a check is made whether a sufficient number of blocks have been transmitted to provide an accurate measurement of throughput. In the preferred embodiment, the throughput measurement test is terminated after a predetermined number of blocks of data have been transmitted. Preferably, that number of blocks is between 200 and 500. In the preferred embodiment 400 blocks are used. However, it is not necessary that the transmission of a predetermined number of blocks be used as the criteria for stopping the throughput measurement. For example, statistical properties of the individual throughput measurements for prior blocks could be used as a criteria for determining at step 222 whether enough blocks had been transmitted. The test might be stopped when the standard deviation of the throughput measurements for prior blocks was less than 5%. Accordingly, the precise technique used at step 222 to determine whether enough blocks have been transmitted is not critical to the invention.

If sufficient blocks have not been transmitted, processing returns to step 214. Returning to step 214 causes another block to be sent and the bit rate measured for this block. If enough blocks have been sent, processing proceeds to step 224. As described above, transmission of data also ends if the timer set at step 212 times out. Thus, step 224 will be executed either when enough blocks have been sent or the maximum allowed test time has been exceeded.

At step 224, the overall bit rate is computed by averaging the bit rates for individual blocks computer at step 220. Bit rate is a measure of the throughput of the network. However, more sophisticated processing could be used to compute the overall bit rate. For example, the bit rates for individual blocks could be statistically analyzed to exclude from the overall computation of bit rate at step 224 those blocks that likely indicate abnormal operating conditions. Excluding measurements made under abnormal operating conditions can increase the overall accuracy of the throughput measurement. However, there are some situations in which excluding bit rate measurements for individual blocks based on statistical properties will actually decrease the accuracy of the overall throughput measurement. Some networks transmit packages of data in a “bursty pattern”. For example, if network 110 represents an internet access network operated by a cable company, the transmit time of a packet sent to computer 112 will depend on the network traffic in their local cable loop. Thus, the throughput measured for the individual blocks will change over time depending on network traffic. We use the term “bursty” to refer to a network in which the instantaneous throughput is expected to change over the period of time that is allocated to the throughput test. On the other hand, where network 110 represents an internet access network operated by a telephone company providing ADSL service, the bit rate measured for the individual blocks in the test is more likely to depend on the physical condition of the lines in the network or other factors that are unlikely to change over the test period. We refer to this condition as a “nonbursty” network. For a nonbursty network, the overall accuracy of the throughput measurement might be increased using statistical analysis to exclude measurements for individual blocks where the instantaneous throughput differed significantly from the average throughput.

In the presently preferred embodiment the processing at step 224 will be implemented with computer software that can be configured to exclude selected ones of the throughputs computed for individual blocks. However, the software will include the ability to disable this feature when used to measure the throughput of a bursty network.

It should be appreciated that the steps in FIG. 2 are illustrative and that the process need not be performed exactly as shown. For example, FIG. 2 shows that the transmit time of a block is measured as the time difference between sending a block and receiving an acknowledgement. It might be preferable to measure the transmit time of a block by measuring the time between receiving at the server acknowledgements from successively transmitted blocks. In this way, the time for the acknowledgement to reach the server and any other fixed delays in the transmit time are excluded from the computation of bit rate.

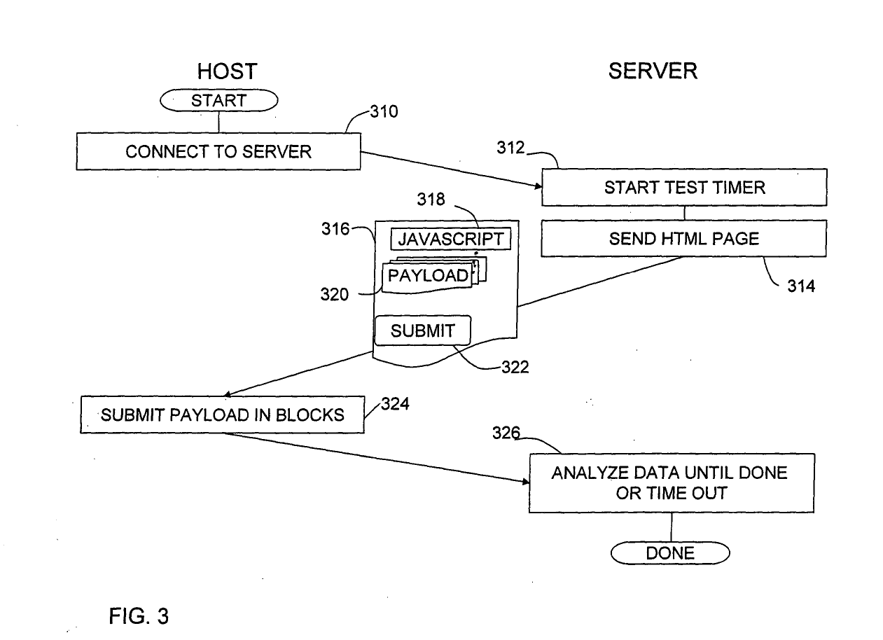

FIG. 3 shows a similar process to measure the upstream throughput. FIG. 3 shows the process starting at step 310 where the host such as the user computer 112 connects to a server. As with FIG. 2 the server is in the preferred embodiment diagnostic unit 116. However, any other server on the network could also be used. Also, it should be appreciated that connecting to the server at step 310 need not require separate user interaction when connecting to the server at step 210. The process of FIG. 3 might automatically execute after the completion of the process shown in FIG. 2.

Regardless of how the connection is established, once the connection is established processing proceeds to step 312. At step 312, the server starts a test timer. As with the downstream measurement process shown in FIG. 2, the upstream measurement process is terminated if not completed in a predetermined amount of time.

The server sends an HTML page to the host computer. Logging onto a website generally causes the transmission of an HTML page and the step of sending an HTML page is not otherwise detailed in FIGS. 2 and 3. However, the specific page sent at step 314 is specially modified to cause the host computer to perform portions of the upstream throughput measurement process.

The HTML page sent at step 314 is illustrated schematically as HTML page 316. HTML page 316 includes executable code here represented as JavaScript® 318. In addition, HTML page 316 includes a payload 320. In the preferred embodiment, payload 320 is a block of data similar to the block of data transmitted at step 216. As described above, the size of the payload is selected to fill a packet of information transmitted over network 110 without being delayed by buffering in the hardware or software that implements the lower level network protocol layers.

HTML page 316 also shown to include a submit button 322. Submit button 322 could be an actual user control displayed by the web browser in computer 112 when it receives HTML page 316. When a user activates submit button 322, JavaScript® 318 begins to execute. In a preferred embodiment, JavaScript® 318 is a simple program that causes the repetitive transfer of messages containing the payload 320 to the server. JavaScript® 318 runs repetitively for some predetermined period of time. Preferably this period of time matches the amount of time allocated for the upstream throughput measurement period. In the presently preferred embodiments this time is preferably between one and fifteen seconds and most preferably approximately ten seconds. It should be appreciated that having a user press submit 322 is not a critical step in the process. As an alternative, HTML page 316 can be configured to have JavaScript® submit automatically when the webpage 316 is loaded into computer 112.

The blocks of data sent at step 324 are received by the server and processed as indicated at step 326. Step 326 analyses the blocks of data generally as described above in connection with FIG. 2. Diagnostic unit 116 or other computer acting as the server records the time at which each block of data is received from the host computer. The time difference between successive blocks is an indication of the amount of time it took for the block of data to pass over network 110. By dividing the size of the block by the transmit time, an estimate of the throughput for the transmission of the block can be determined. Step 326 analyses the throughput measurements of the individual blocks as described above in connection with FIG. 2. The analysis includes determining whether enough blocks of data have been received to accurately compute the throughput. Step 326 also checks to determine whether the maximum amount of time for the upstream throughput measurement has been exceeded. As described above, this check can be performed in many ways, such as by examining whether the value in the test time set at step 312 has exceeded a predetermined value.

When sufficient data has been collected, either because a sufficient number of blocks have been received or a sufficiently long period of time has passed, the overall throughput is also computed by step 326. In the preferred embodiment, the overall throughput is reported to call center 122 where this information is used in diagnosing a network problem or facilitating the resolution of a customer complaint.

If the server at step 326 determines that the overall throughput should be computed based on measurements of blocks already received, the server might send a message to the host indicating that the connection between the host and the server is severed. The HTML protocol includes session controlled messages that allow the server to signal the host that the connection is severed. For most commercial web browsers that might be used on host computer, receiving such a message would result in the execution of JavaScript® 318 being terminated. In this way the host would not transmit more data than necessary. However, we have observed that sending an end of session message causes some commercially available web browsers to display a notification to the user. Where it is desired to avoid the possibility that such a notification would be displayed to the user of computer 112, it is not necessary that server 112 send an end of session message. In this case, JavaScript® 318 will stop executing when it has run for a predetermined period of time. In the presently preferred embodiment, JavaScript® 318 will time out and stop sending data after a time that is preferably between five and ten seconds.

The processes shown in FIGS. 2 and 3 are representative of the high level logic of a program that could be written to implement a technique according to the invention One of skill in the art could develop alternative programs that also utilize the invention. For example, step 220 is indicated as computing the bit rate for individual blocks and step 224 is indicated as computing the overall bit rate. The order in which the various mathematical operations are performed is not critical to the invention. For example, the average of the bit rates for the individual blocks could be computed by first computing the bit rate for each individual block and then averaging the numbers. However, a numerically equivalent result can be achieved by adding together the number of bits in all the blocks transmitted and then dividing by the time it took to transmit that number of blocks. As a further alternative, it should be noted that in the preferred embodiment all of the blocks are of the same size. It is not necessary that all blocks be the same size. However, where the blocks are the same size, the size of the block becomes a constant scale factor that can be applied to the equations that compute the bit rate at any convenient time.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method of measuring the throughput of a network, comprising:
a) transmitting a block of data over the network;
b) measuring a value representative of the transmit time of the block;
c) computing the data transmission rate of the block;
d) repeating steps a), b) and c) until a stop event occurs, wherein the stop event is the first to occur of transmitting a number of blocks or the passage of an amount of time; and
e) computing the network throughput by averaging the data transmission rates of selected ones of the blocks.

2. The method of claim 1 wherein the selected ones of the blocks consists of all of the blocks for which a data rate was computed during the measurement when the network is known to be a bursty network.

3. The method of claim 1 wherein the selected ones of the blocks consists of only those blocks for which the data rate was computed to be less than a prescribed amount from the average data transmission rates of all the blocks transmitted during the measurement when the network is known to be a non-bursty network.

4. The method of claim 1 wherein the size of a block of data is selected to fit within a network packet.

5. The method of claim 4 wherein the size of a block of data is selected to cause the application layer of a computer connected to the network to pass a message containing the block to the network without buffering delay.

6. The method of claim 5 wherein the transmit time is measured at the application programming layer of a computer connected to the network.

7. The method of claim 1 wherein transmitting a block of data comprises generating a message from an application program running on an operating system that establishes a socket having a buffer and the method additionally comprises setting the size of the socket buffer.

8. The method of claim 1 wherein the size of a block of data is less than 2 kilobytes.

9. The method of claim 1 wherein the throughput is measured in the upstream throughput and the method additionally comprises measuring the downstream throughput.

10. A method of measuring the throughput of a network, comprising:
a) establishing a connection between a user computer and a server;
b) presenting, with the server, a diagnostic web page to the user;
c) repetitively transmitting blocks of data over the network between the user computer and the server until a stop event occurs, wherein the stop event is the first to occur of transmitting a number of blocks or the passage of an amount of time;
d) measuring a value representative of the transmit time of the block; and
e) computing the network throughput by averaging the data transmission rates of selected ones of the blocks.

11. The method of claim 10 wherein the web page is presented to the user as an HTML page that contains a script that causes the user computer to transmit blocks of data to the server.

12. The method of claim 11 wherein the network is an ADSL network and the computed throughput represents the upstream throughput.

13. The method of claim 12 wherein the downstream throughput is separately measured.

14. The method of claim 11 wherein the HTML page additionally contains a test payload that is transmitted in the blocks of data.

15. The method of claim 10 wherein repetitively transmitting blocks of data wherein:
a) transmitting a block of data comprises transmitting a block from the server to the user computer; and
b) the value representative of transmit time is derived from the time between successive acknowledgements from the user computer.

16. The method of claim 10 wherein the server is a diagnostic unit installed in the network.

17. The method of claim 10 additionally comprising:
a) receiving a call from the network user at a call center operated by the network operator;
b) directing the user to access the diagnostic web page and receiving the result;
c) receiving, for use at the call center, the computed network throughput.

18. The method of claim 10 wherein the passage of time is less than 10 seconds.

19. The method of claim 10 additionally comprising providing the computed throughput to a call enter for an internet service provider.

20. The method of claim 10 wherein the network is a nonbursty network and the selected ones of the blocks are selected based on the relationship between the transmit time of the block and the average transmit time of all other blocks.

21. A network configured for measuring throughput experienced by a user in the access portion of a network, comprising a diagnostic unit connected to the network, the diagnostic unit having programming that:
a) presents a diagnostic web page to a user computer when the user accesses the diagnostic unit;
b) controls the repetitive transmission of blocks of data over the access network between the user computer and the diagnostic unit;
c) measures a value representative of the transmit time of the block; and
d) computes the network throughput by averaging the data transmission rates of selected ones of the blocks received before a stop event occurs, wherein the stop event is the first to occur of transmitting a number of blocks or the passage of an amount of time.

22. The network of claim 21 wherein the diagnostic unit is programmed to measure throughput in the upstream and downstream directions.

23. The network of claim 22 wherein the diagnostic unit measures downstream throughput by transmitting blocks of data to the user computer and measures a value representative of time by measuring the time difference between acknowledgement messages sent by the user computer.

24. The network of claim 23 wherein the diagnostic unit measures upstream throughput by embedding code within the web page when presented to the user computer, and that code causes the user computer to send successive blocks of data to the diagnostic unit.

25. The network of claim 21 wherein the programming is an application program running on an operating system and the operating system enables communication over the network between the application program and the user computer by establishing a socket that has a buffer and the application program additionally comprises programming that sets the size of the socket buffer.

26. The network of claim 25 wherein the size of the socket buffer is set to between 2 Kbytes and 16 Kbytes.

27. The network of claim 26 wherein the size of the socket buffer is set to between 8 Kbytes and 12 Kbytes.
